(19) United States
(12) Patent Application Publication
(10) Pub. No.: US 2021/0214234 A1
(43) Pub. Date: Jul. 15, 2021

(54) Carbonaceous Material for Negative Electrode Active Material Additive for Lithium Secondary Battery

(71) Applicant: AEKYUNGPETROCHEMICALCO.,LTD, Seoul (KR)

(72) Inventors: Jang Ho Lee, Daejeon (KR); Byung Mok Chae, Daejeon (KR); Sang Won Cho, Daejeon (KR); Dong Ju Lee, Daejeon (KR); Su Bin Jeong, Daejeon (KR)

(21) Appl. No.: 16/757,899

(22) PCT Filed: Nov. 13, 2019
(86) PCT No.: PCT/KR2019/015425

§ 371 Date: Apr. 21, 2020

(30) Foreign Application Priority Data
Feb. 15, 2019 (KR) 10-2019-0017950

(51) Int. Cl. C01B 32/90; H01M 10/0525

(52) U.S. Cl. CPC C01B 32/90; H01M 10/0525; C01P 2002/78; C01P 2006/12; C01P 2004/51

(57) ABSTRACT

Provided is a carbonaceous material for a negative electrode active material additive for a lithium secondary battery, which has Dᵥ50 of 6 μm or less and Dₙ50 of 1 μm or less. According to the carbonaceous material for a negative electrode active material additive for a lithium secondary battery of an embodiment of the present invention, since lithium ions may be rapidly adsorbed to and desorbed from a negative electrode adopting the carbonaceous material, output characteristics of a lithium secondary battery including the carbonaceous material are improved, and since a decrease in a capacity is small even when repeatedly charged and discharged, life characteristics are excellent.

### TECHNICAL FIELD

The present invention relates to a lithium secondary battery, and more particularly, to a carbonaceous material for a negative electrode active material additive for a lithium secondary battery.

### BACKGROUND ART

A study of a battery having a higher capacity for increasing a cruising range for commercialization of an electric vehicle, has been actively conducted.

Since graphite which is often used as a negative electrode active material for a lithium secondary battery has a low theoretical capacity, there is a limitation in increasing the cruising range, and thus, attempts to apply a new high-capacity negative electrode active material such as an Si-based negative electrode active material are being actively made.

However, this study is still insufficient for commercialization and much time is currently needed for commercialization.

Thus, in order to speed up commercialization of an electric vehicle, alternatively, another approach to improve a charge-discharge rate instead of increasing a cruising range may be considered.

In order to improve the charge-discharge rate, lithium ions should be rapidly adsorbed to and desorbed from the negative electrode of a lithium secondary battery, but in the case of graphite, it is difficult to implement large current input characteristics and thus, quick charge and discharge are difficult, and life characteristics are not good.

Thus, it is required to develop a new negative electrode-related material which has excellent output characteristics to allow quick charge and discharge and may implement excellent life characteristics.

### DISCLOSURE

### Technical Problem

An object of the present invention is to provide a carbonaceous material for a negative electrode active material additive for a lithium secondary battery which has improved input characteristics and may implement excellent life characteristics.

### Technical Solution

In one general aspect, a carbonaceous material for a negative electrode active material additive for a lithium secondary battery has Dᵥ50 of 6 μm or less and Dₙ50 of 1 μm or less.

Dᵥ50 refers to a particle diameter when a cumulative volume is at 50% from a small diameter in a particle size distribution measurement by a laser scattering method, and Dₙ50 refers to a particle diameter when a cumulative number of particles is at 50% from a small particle diameter in a particle size distribution measurement by a laser scattering method.

The carbonaceous material may have Dᵥ10 of 2.2 μm or less and Dₙ10 of 0.6 μm or less.

Dᵥ10 refers to a particle diameter when a cumulative volume is at 10% from a small diameter in a particle size distribution measurement by a laser scattering method, and Dₙ10 refers to a particle diameter when a cumulative number of particles is at 10% from a small particle diameter in a particle size distribution measurement by a laser scattering method.

The carbonaceous material may have Dᵥ90 of 11 μm or less and Dₙ90 of 3 μm or less.

Dᵥ90 refers to a particle diameter when a cumulative volume is at 90% from a small diameter in a particle size distribution measurement by a laser scattering method, and Dₙ90 refers to a particle diameter when a cumulative number of particles is at 90% from a small particle diameter in a particle size distribution measurement by a laser scattering method.

The carbonaceous material may have a BET specific surface area of 3 m²/g or more and 10 m²/g or less.

The carbonaceous material may have a (002) average layer spacing (d(002)) of 3.4 Å or more and 4.0 Å or less as determined by an X-ray diffraction method.

The carbonaceous material may have a crystallite diameter in the direction of the C-axis, Lc (002) of 0.8 nm or more and 2 nm or less.

The carbonaceous material is added to a carbon-based negative electrode active material, and an addition amount of the carbonaceous material may be 5 wt % or less with respect to 100 wt % of the total amount of the carbon-based negative electrode active material and the carbonaceous material.

The carbonaceous material may include a carbide obtained by heat-treating a polyurethane resin containing 150 parts by weight or more and 240 parts by weight or less of an isocyanate with respect to 100 parts by weight of a polyol, under an inert gas atmosphere to carbonize the polyurethane resin.

The polyol may be any one or two or more selected from the group consisting of a polyether-based polyol, a polyester-based polyol, a polytetramethylene ether glycol polyol, a poly Harnstoff dispersion (PHD) polyol, an amine-modified polyol, a Mannich polyol, and mixtures thereof.

The isocyanate may be any one or two or more selected from the group consisting of hexamethylene diisocyanate (HDI), isophorone diisocyanate (IPDI), 4,4′-dicyclohexylmethane diisocyanate (H12MDI), polyethylene polyphenyl diisocyanate, toluene diisocyanate (TDI), 2,2′-diphenylmethane diisocyanate (2,2′-MDI), 2,4′-diphenylmethane diisocyanate (2,4′-MDI), 4,4′-diphenylmethane diisocyanate (4,4′-MDI, monomeric MDI), polymeric diphenylmethane diisocyanate (polymeric MDI), orthotoluidine diisocyanate (TODI), naphthalene diisocyanate (NDI), xylene diisocyanate (XDI), lysine diisocyanate (LDI), and triphenylmethane triisocyanate (TPTI).

### Advantageous Effects

According to the carbonaceous material for a negative electrode active material additive for a lithium secondary battery of an embodiment of the present invention, since lithium ions may be rapidly adsorbed to and desorbed from a negative electrode adopting the carbonaceous material, output characteristics of a lithium secondary battery including the carbonaceous material are improved, and a decrease in a capacity is small even when repeatedly charged and discharged, and thus, life characteristics may be excellent.

### DESCRIPTION OF DRAWINGS

FIG. 1 is output characteristic evaluation data according to the experimental example of the present invention.

FIG. 2 is output characteristic evaluation data according to the experimental example of the present invention.

FIG. 3 is life characteristic evaluation data according to the experimental example of the present invention.

### BEST MODE

Unless otherwise defined herein, all terms used in the specification (including technical and scientific terms) may have the meaning that is commonly understood by those skilled in the art to which the present invention pertains. Throughout the present specification, unless explicitly described to the contrary, “comprising” any elements will be understood to imply further inclusion of other elements rather than the exclusion of any other elements. In addition, unless explicitly described to the contrary, a singular form includes a plural form herein.

[symbol]

An embodiment of the present invention provides a carbonaceous material for a negative electrode active material for a lithium secondary battery which, when included in the negative electrode active material for a lithium secondary battery as an additive, may implement excellent output characteristics of a lithium secondary battery at a high rate, and simultaneously, maintain excellent life characteristics.

According to the carbonaceous material for a negative electrode active material additive for a lithium secondary battery of an embodiment of the present invention, since lithium ions may be rapidly adsorbed to and desorbed from a negative electrode adopting the carbonaceous material, output characteristics of a lithium secondary battery including the carbonaceous material are improved, and a decrease in a capacity is small even when repeatedly charged and discharged, and thus, life characteristics may be excellent.

[symbol]

Specifically, an embodiment of the present invention provides a carbonaceous material for a negative electrode active material additive for a lithium secondary battery having Dᵥ50 of 6 μm or less and Dₙ50 of 1 μm or less.

Dᵥ50 refers to a particle diameter when a cumulative volume is at 50% from a small diameter in a particle size distribution measurement by a laser scattering method, and Dₙ50 refers to a particle diameter when a cumulative number of particles is at 50% from a small particle diameter in a particle size distribution measurement by a laser scattering method.

The carbonaceous material for a negative electrode active material additive for a lithium secondary battery of an embodiment of the present invention is fine powder having a small average particle diameter and may be positioned in voids between main active materials, and thus, does not increase the volume of the negative electrode and does not cause a decrease in energy density. At the same time, excellent output characteristics and life characteristics may be implemented.

Specifically, when Dᵥ50 is 6 μm or less and Dₙ50 is 1 μm or less as measured by a laser scattering method, particles which are fine powder overall and have a particle diameter of 1 μm or less account for 50% or more, whereby the additive is more easily positioned in voids between the main active materials to implement the effects described above.

In addition, the carbonaceous material for a negative electrode active material additive for a lithium secondary battery of an embodiment of the present invention is fine powder having a small average particle diameter and may be positioned in voids between the main active materials, whereby when the same weight of the material is added, the number of particles may be increased with respect to the weight, and thus, excellent output characteristics and life characteristics may be implemented without a decrease in energy density even when a low content is added.

Here, for Dᵥ50 and Dₙ50, the particle size distribution may be measured by collecting a sample from the prepared carbonaceous material according to a KS A ISO 13320-1 standard and using Mastersizer 3000 from Malvern Panalytical Ltd. Specifically, after particles are dispersed in ethanol as a solvent, if necessary, using an ultrasonic disperser, a volume density and a number density may be measured.

In addition, when the carbonaceous material additive of fine powder of an embodiment of the present invention is included as a negative electrode active material additive, the output characteristics and the life characteristics of a lithium secondary battery may be implemented with a small amount of addition.

For example, the carbonaceous material of an embodiment of the present invention is added to a carbon-based negative electrode active material, and when the addition amount of the carbonaceous material is small, which is 5 wt % or less with respect to 100 wt % of the total amount of the carbon-based negative electrode active material and the carbonaceous material, the output characteristics and the life characteristics of a lithium secondary battery may be improved without a decrease in energy density.

In addition, since the addition amount is small relative to the amount of the main active material, there is no difficulty in preparing a slurry due to an increase in a specific surface area of an active material, and a phenomenon in which the main active material interferes with a conduction path may be much suppressed.

More specifically, 1 wt % or more and 5 wt % or less, or 2 wt % or more and 4 wt % or less of the carbonaceous material may be added. However, the present invention is not necessarily limited thereto.

In addition, the main active material in an embodiment of the present invention may be a carbon-based negative electrode active material such as natural graphite or artificial graphite, or a silicon-based negative electrode active material such as Si or SiC, but is not particularly limited thereto. In the present invention, it was confirmed that when the carbonaceous material is added to spheroidal natural graphite as an additive, output characteristics and life characteristics are improved.

In addition, Dᵥ50 may be more specifically 4 μm or less and Dₙ50 may be 0.5 μm or less, and in this case, it was confirmed from the examples described later that excellent output characteristics and life characteristics are implemented.

In addition, Dᵥ50 may be 1 μm or more and Dₙ50 may be 0.3 μm or more, but they are not limited thereto.

The carbonaceous material for a negative electrode active material additive for a lithium secondary battery of an embodiment of the present invention may have Dᵥ10 of 2.2 μm or less and Dₙ10 of 0.6 μm or less.

Dᵥ10 refers to a particle diameter when a cumulative volume is at 10% from a small diameter in a particle size distribution measurement by a laser scattering method, and Dₙ10 refers to a particle diameter when a cumulative number of particles is at 10% from a small particle diameter in a particle size distribution measurement by a laser scattering method.

As confirmed from the examples described later, when Dᵥ10 and Dₙ10 of the carbonaceous material for a negative electrode active material additive for a lithium secondary battery of an embodiment of the present invention satisfy the above range, excellent output characteristics and life characteristics may be implemented.

More specifically, Dᵥ10 may be 1.5 μm or less and Dₙ10 may be 0.3 μm or less, but the present invention is not necessarily limited thereto.

In addition, Dᵥ10 may be 0.5 μm or more and Dₙ10 may be 0.2 μm or more, but they are not limited thereto.

The carbonaceous material for a negative electrode active material additive for a lithium secondary battery of an embodiment of the present invention may have Dᵥ90 of 11 μm or less and Dₙ90 of 3 μm or less.

Dᵥ90 refers to a particle diameter when a cumulative volume is at 90% from a small diameter in a particle size distribution measurement by a laser scattering method, and Dₙ90 refers to a particle diameter when a cumulative number of particles is at 90% from a small particle diameter in a particle size distribution measurement by a laser scattering method.

As confirmed from the examples described later, when Dᵥ90 and Dₙ90 of the carbonaceous material for a negative electrode active material additive for a lithium secondary battery satisfy the above range, excellent output characteristics and life characteristics may be implemented.

More specifically, Dᵥ90 may be 6 μm or less and Dₙ90 may be 2 μm or less, but the present invention is not necessarily limited thereto.

In addition, Dᵥ90 may be 4 μm or more and Dₙ90 may be 1.5 μm or more, but they are not limited thereto.

The carbonaceous material for a negative electrode active material additive for a lithium secondary battery of an embodiment of the present invention may have a BET specific surface of 3 m²/g or more and 10 m²/g or less, and more specifically 4 m²/g or more and 10 m²/g or less. When these ranges are satisfied, since a side reaction with an electrolyte solution is small, a capacity decrease due to an initial irreversible capacity increase may be prevented, and excellent output characteristics and life characteristics of a lithium secondary battery may be implemented, which is thus preferred, but the present invention is not necessarily limited thereto.

The carbonaceous material for a negative electrode active material additive for a lithium secondary battery of an embodiment of the present invention may have a (002) average layer spacing (d(002)) of 3.4 Å or more and 4.0 Å or less, and more specifically 3.6 Å or more and 3.8 Å or less. In these ranges, excellent output characteristics and life characteristics may be implemented, which is thus preferred, but the present invention is not necessarily limited thereto.

In an embodiment of the present invention, the (002) average layer spacing may be measured by obtaining a graph of a 2θ value measured using an X-ray diffraction method under the conditions of a wavelength of a Ka line of Cu of 0.15406 nm, a measurement range of 2.5 to 80°, and a measurement speed of 5°/min, determining a peak position of the graph by an integration method, and calculating d(002) by a Bragg equation (d(002)=λ/2 sin θ).

The carbonaceous material for a negative electrode active material additive for a lithium secondary battery of an embodiment of the present invention may have a crystallite diameter in the direction of the C-axis, Lc(002) of 0.8 nm or more and 2 nm or less, and more specifically 0.9 nm or more and 1.1 nm or less. In these ranges, excellent output characteristics and life characteristics may be implemented, which is thus preferred, but the present invention is not necessarily limited thereto.

In an embodiment of the present invention, the crystallite diameter in the direction of the C-axis, Lc(002) may be calculated by a Scherrer equation under the following conditions:
Lc(002)=Kλ/β cos θ
K=Scherrer constant (0.9)
β=full width at half maximum (FWHM)
−λ=x-ray wavelength value, 0.154056 nm
θ=angle of diffraction

[symbol]

Hereinafter, a method of preparing the carbonaceous material for a negative electrode active material additive for a lithium secondary battery of an embodiment of the present invention will be described. However, this is an example, and the method of preparing the carbonaceous material of the present invention is not necessarily limited thereto.

The carbonaceous material for a negative electrode active material additive for a lithium secondary battery of an embodiment of the present invention may be prepared by heat-treating a polyurethane resin containing 150 parts by weight or more and 240 parts by weight or less of an isocyanate with respect to 100 parts by weight of a polyol, under an inert gas atmosphere to carbonize the polyurethane resin, and then pulverizing the carbide so as to satisfy the particle size range described above.

This preparation process allows preparation of the carbonaceous material, which when used as a negative electrode active material additive for a lithium secondary battery, has a specific surface area allowing excellent output characteristics and life characteristics to be implemented, has a surface in which mesopores are not developed, to be formed to prevent moisture in the air from being adsorbed, allows easy removal of moisture in an electrode drying process, thereby significantly improving the initial efficiency, the output characteristics, and the life characteristics of a lithium secondary battery.

The polyol is a common compound used in the preparation of a polyurethane resin and not particularly limited, but specifically, may be any one or two or more selected from the group consisting of a polyether-based polyol, a polyester-based polyol, a polytetramethylene ether glycol polyol, a poly Harnstoff dispersion (PHD) polyol, an amine-modified polyol, a Mannich polyol, and mixtures thereof, and more specifically, may be a polyester polyol, an amine-modified polyol, a Mannich polyol, or a mixture thereof

The polyol may have a number average molecular weight (Mn) of 300 or more and 3000 or less, and more specifically 400 or more and 1500 or less. When these ranges are satisfied, the thermal stability of the polymerized polyurethane resin may be improved and melting occurrence in a carbonization process may be suppressed, which is thus preferred, but the present invention is not necessarily limited thereto.

The number of hydroxyl groups in the polyol may be 1.5 or more and 6.0 or less, and more specifically 2.0 or more and 4.0 or less. In addition, the content of the hydroxyl group present in the polyol may be 3 wt % or more and 15 wt % or less. When these ranges are satisfied, the carbonaceous material having a specific surface area and surface characteristics in preferred ranges may be prepared, which is thus preferred, but the present invention is not necessarily limited thereto.

The isocyanate reacted with the polyol is a common polyol used in the preparation of a polyurethane resin and is not particularly limited, but specifically, may be any one or two or more selected from the group consisting of hexamethylene diisocyanate (HDI), isophorone diisocyanate (IPDI), 4,4′-dicyclohexylmethane diisocyanate (H12MDI), polyethylene polyphenyl diisocyanate, toluene diisocyanate (TDI), 2,2′-diphenylmethane diisocyanate (2,2′-MDI), 2,4′-diphenylmethane diisocyanate (2,4′-MDI), 4,4′-diphenylmethane diisocyanate (4,4′-MDI, monomeric MDI), polymeric diphenylmethane diisocyanate (polymeric MDI), orthotoluidine diisocyanate (TODI), naphthalene diisocyanate (NDI), xylene diisocyanate (XDI), lysine diisocyanate (LDI), and triphenylmethane triisocyanate (TPTI). More specifically, the isocyanate may be 4,4′-diphenylmethane diisocyanate (4,4′-MDI, monomeric MDI), polymeric diphenylmethane diisocyanate (polymeric MDI), or polyethylene polyphenyl isocyanate.

The mixing ratio of the polyol and the isocyanate may be 150 parts by weight or more and 240 parts by weight or less of the isocyanate with respect to 100 parts by weight of the polyol. When these ranges are satisfied, the thermal stability of the polymerized polyurethane resin may be improved and melting occurrence in a carbonization process may be suppressed, which is thus preferred, but the present invention is not necessarily limited thereto.

In addition, in order to prepare the polyurethane resin, a catalyst may be added for inducing a reaction of the polyol and the isocyanate. As the catalyst, any one or two or more selected from the group consisting of pentamethyldiethylene triamine, dimethyl cyclohexyl amine, bis-(2-dimethyl aminoethyl)ether, triethylene diamine, potassium octoate, tris(dimethylaminomethyl)phenol, potassium acetate, or a mixture thereof may be used, and the content of the catalyst may be 0.1 parts by weight or more and 5 parts by weight or less with respect to the polyol.

In addition, in order to facilitate pulverization of the polyurethane resin, a foaming agent such as water and CO2 may be included, and a foam stabilizer may be further included for improving polyurethane resin quality.

In addition, in order to improve the thermal stability of the polyurethane resin, a flame retardant such as tris(2-chloropropyl) phosphate (TCPP), tris(2-chlroroethyl) phosphate (TCEP), triethyl phosphate (TEP), and trimethyl phosphate (TMP) may be further added.

Since the mixing ratio of the polyol and the isocyanate may vary depending on the content of an additive such as a catalyst, a foam stabilizer, a foaming agent, and a flame retardant, the range is not limited to the above.

The carbonization of the prepared polyurethane resin may be performed by heat-treating the polyurethane resin under an inert gas atmosphere, for example, at a temperature of 700° C. or higher and 1500° C. or lower.

The inert gas may be helium, nitrogen, argon, or mixed gas thereof, but is not limited thereto.

Here, the polyurethane resin may be pulverized before heat treatment for adjusting a heat transfer distance and a carbonization degree.

When the polyurethane resin in a bulk state is subjected to a pulverization step as the pulverization, the pulverization may be performed by a crusher as a mechanical pulverization method, or performed as pulverization in a single step or in multiple steps by dividing the single step. In the present invention, the pulverization method before heat treatment is not particularly limited.

In addition, the carbonization step may be performed by including a preliminary carbonation step and a main carbonization step, and in the preliminary carbonization step, the heat treatment was performed at a temperature of 600° C. or higher and 1000° C. or lower for 30 minutes or more and 120 minutes or less, and in the main carbonization step, the heat treatment was performed at a temperature of 1000° C. or higher and 1400° C. or lower for 30 minutes or more and 120 minutes or less. In addition, it is preferred that the preliminary carbonization step and the main carbonization step may sequentially proceed.

Meanwhile, a fine pulverization step in which the additive is pulverized into a suitable size may be performed between the preliminary carbonization step and the main carbonization step.

The fine pulverization step may be performed using a conventional pulverizer using a mechanical pulverization method, and for example, may be performed using various pulverization devices such as a ball mill, a pin mill, a rotor mill, and a jet mill.

In addition, in the main fine pulverization step, an adjustment may be performed to have the particle size distribution of the carbonaceous material for a negative electrode active material additive for a lithium secondary battery of an embodiment of the present invention.

Hereinafter, the preferred Examples and Comparative Examples of the present invention will be described. However, the following Examples are only a preferred exemplary embodiment of the present invention, and the present invention is not limited thereto.

<Evaluation Test Items>

1) Particle Size Distribution Analysis

A sample of a prepared carbonaceous material was collected according to a KS A ISO 13320-1 standard, and the particle size distribution thereof was measured using Mastersizer 3000 from Malvern Panalytical Ltd. After particles were dispersed in ethanol as a solvent, if necessary, using an ultrasonic disperser, a volume density and a number density were measured.

2) XRD Analysis

[symbol] Analysis of Average Layer Spacing (d(002) of Particles

A graph of a 2θ value measured using an X-ray diffraction method was obtained, the peak position of the graph was determined by an integration method, and d(002) was calculated by a Bragg equation (d(002)=λ/2 sin θ). The wavelength of Ka line of Cu was 0.15406 nm. Here, a measurement range was from 2.5 to 80°, and a measurement speed was 5°/min.

[symbol] Analysis of Crystalline Size of Particles

A crystallite thickness of particles in the direction of the C-axis, Lc(002) was calculated by a Scherrer equation.
Lc(002)=Kλ/βcos δ
K=Scherrer constant (0.9)
β=full width at half maximum (FWHM)
λ=x-ray wavelength value, 0.154056 nm
θ=angle of diffraction

3) Specific Surface Area Measurement

A sample was collected according to KS A 0094 and KS L ISO 18757 standards and subjected to a degassing treatment at 300° C. for 3 hours by a pretreatment device, and then the specific surface area of the sample was measured in a pressure section (P/P0) of 0.05 to 0.3 by a gas adsorption BET method of nitrogen gas by ASAP2020 from Micromeritics Instrument Corporation.

4) Measurement Method of Measurement Cell and Evaluation of Charge-Discharge Characteristics

As a measurement cell, an electrode which was manufactured by a negative electrode active material mixture in which pitch-coated spheroidal natural graphite (average particle diameter: 12 μm) and the carbonaceous material of the present invention are mixed at a weight ratio shown in the following Table 2 and a binder (carboxymethyl cellulose:styrene-butadiene rubber=50:50) at a ratio of 97:3, as a coin type half cell, and a lithium metal foil as a counter electrode were used, with a separator interposed between the electrode, and an electrolyte solution in which EC/EMC/DMC as an organic electrolyte solution is mixed at a ratio of 1:1:1 and 1M LiPF₆ is dissolved therein was impregnated thereinto, thereby manufacturing a 2016 type coin cell.

An initial charge-discharge capacity was measured as follows.

Charge was performed by intercalating lithium ions in a carbon electrode by a constant current to 0.005 V at 0.1 C rate, proceeding with lithium ion intercalation from 0.005 V by a constant voltage, and finishing the lithium ion intercalation when the current reached the current corresponding to a 0.01 C rate. Discharge was performed by deintercalating lithium ions from the carbon electrode at a 0.1 C rate with a termination voltage of 1.5 V by a constant current method.

Here, a value obtained by dividing supplied quantity of electricity by the weight of the negative electrode active material of the electrode was set as a specific capacity (mAh/g, discharge specific capacity at discharge, charge specific capacity at charge) of the negative electrode active material. Here, the first specific capacity at discharge was set as an initial capacity, and initial efficiency was calculated as a percentage (%) of the initial specific capacity at discharge relative to a first specific capacity at charge.

5) Life Characteristic Evaluation

Life characteristic evaluation was performed at room temperature by a constant current-constant voltage method (CCCV) as described above, and after 3 cycles of charge-discharge was initially performed at a 0.1 C rate, charge at a 0.2 C rate and discharge at a 0.5 C rate were performed up to 50 cycles. A performance indicator was represented as a capacity retention ratio (CRR) of a specific capacity at discharge at room temperature, and this was calculated as a percentage (%) of the specific capacity at discharge in each cycle relative to the first specific capacity at discharge.

6) Evaluation of High-Rate Discharge Characteristics at Room Temperature

Evaluation of high-rate discharge characteristics at room temperature was measurement of the output characteristics at lithium ion discharge at 25° C., and performed by performing initial 3 cycles of charge-discharge at a 0.1 C rate, 1 cycle of charge-discharge at a 0.2 C rate, and thereafter, increasing only the discharge (lithium ion deintercalation) C-rate from 1 to 5 C stepwise.

### Examples 1 to 3 and Comparative Example 1

100 g of a polyol having 7 wt % of an acidic group (AKP SSP-104) and 195 g of 4,4′-MDI were stirred at a speed of 4000 rpm for 10 seconds to prepare a cured polyurethane resin.

The polyurethane resin was pulverized into a particle size of 0.1 to 2 mm using a pulverizer, the pulverized product was heated to 700° C. in a nitrogen gas atmosphere and maintained at 700° C. for 1 hour to perform preliminary carbonization, thereby obtaining a negative electrode active material additive precursor for a lithium secondary battery having a carbonization yield of 38%.

The thus-obtained negative electrode active material additive precursor was finely pulverized using a jet mill, in which the finely pulverized sizes in Examples 1 to 3 and Comparative Example 1 were differently adjusted.

The finely pulverized negative electrode active material additive precursor was placed in a crucible made of ceramic, heated to 1200° C. at a heating rate of 5° C./min under a nitrogen gas atmosphere, and maintained at 1200° C. for 1 hour to undergo a carbonization process, thereby preparing a carbonaceous material which may be used as a negative electrode active material additive for a lithium secondary battery.

The particle size distribution based on volume density, particle size distribution based on number density, BET specific surface area, d(002), and Lc(002) values for the carbonaceous materials prepared in Examples 1 to 3 and Comparative Example 1 are summarized in Table 1.

TABLE 1

| | | | | | | | | BET Specific | | |
|---|---|---|---|---|---|---|---|---|---|---|
| | PSD(μm) | | | | | | | surface area | d(002) | Lc(002) |
| Classification | Type | D1 | D10 | D50 | D90 | D100 | Span | (m²/g) | (Å) | (nm) |
| Example 1 | Volume density | 0.57 | 1.43 | 2.98 | 5.78 | 11.0 | 1.46 | 9.89 | 3.67 | 0.98 |
| | Number density | 0.25 | 0.27 | 0.47 | 1.81 | 8.58 | 3.28 | | | |
| Example 2 | Volume density | 0.82 | 2.05 | 4.12 | 7.22 | 11.2 | 1.26 | 5.50 | 3.70 | 1.06 |
| | Number density | 0.47 | 0.52 | 0.93 | 2.92 | 10.5 | 2.58 | | | |
| Example 3 | Volume density | 0.77 | 2.11 | 5.34 | 10.3 | 21.0 | 1.53 | 4.17 | 3.78 | 0.97 |
| | Number density | 0.41 | 0.47 | 0.81 | 2.32 | 14.1 | 2.29 | | | |
| Comparative | Volume density | 1.09 | 2.80 | 7.96 | 14.5 | 24.0 | 1.47 | 3.63 | 3.76 | 0.99 |
| Example 1 | Number density | 0.57 | 1.95 | 6.04 | 11.7 | 21.2 | 1.61 | | | |

Thereafter, an electrode adopting the negative electrode active material as shown in the following Table 2 was used to manufacture a 2016 type coin cell as described above.

TABLE 2

| Classi- | Composition of negative electrode active material |
|---|---|
| fication | (% means wt %) |
| [symbol] | 97% of spheroidal natural graphite + 3% of carbonaceous |
| | material of Example 1 (loading amount: 7.6 mg/cm², electrode |
| | density: 1.6 g/cc) |
| [symbol] | 97% of spheroidal natural graphite + 3% of carbonaceous |
| | material of Example 1 (loading amount: 6.4 mg/cm², electrode |
| | density: 1.6 g/cc) |
| [symbol] | 97% of spheroidal natural graphite + 3% of carbonaceous |
| | material of Example 2 (loading amount: 6.4 mg/cm², electrode |
| | density: 1.6 g/cc) |
| [symbol] | 97% of spheroidal natural graphite + 3% of carbonaceous |
| | material of Example 3 (loading amount: 6.4 mg/cm², electrode |
| | density: 1.6 g/cc) |
| [symbol] | 100% of spheroidal natural graphite (loading amount: 7.6 |
| | mg/cm², electrode density: 1.6 g/cc) |
| [symbol] | 90% of spheroidal natural graphite + 10% of carbonaceous |
| | material of Comparative Example 1 (loading amount: 7.6 |
| | mg/cm², electrode density: 1.6 g/cc) |
| [symbol] | 97% of spheroidal natural graphite + 3% of carbonaceous |
| | material of Comparative Example 1 (loading amount: 7.6 |
| | mg/cm², electrode density: 1.6 g/cc) |

### Experimental Example 1

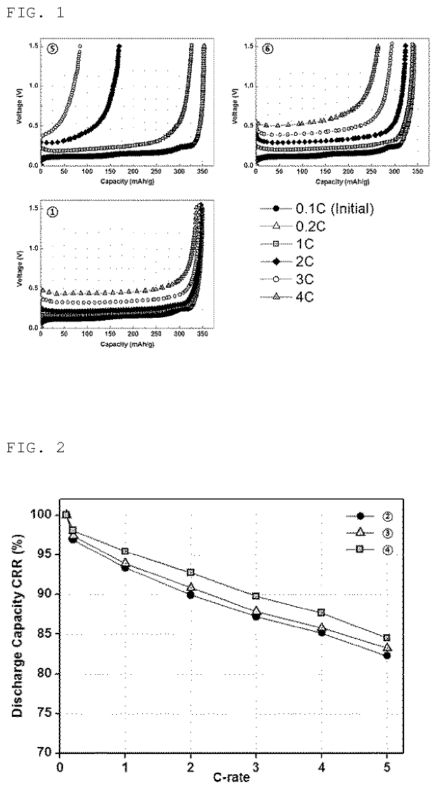

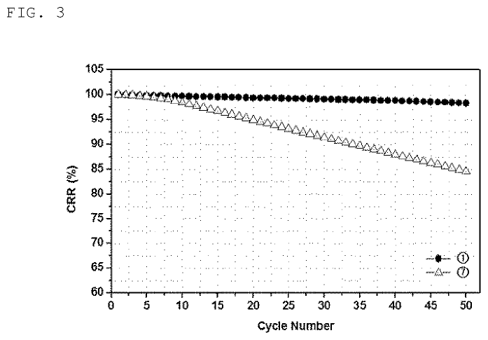

The output characteristics at room temperature were evaluated for the coin cells manufactured above, according to the evaluation method described above, and the results are summarized in FIG. 1, FIG. 2, and Table 3.

TABLE 3

| | Initial | Effi- | Discharge capacity for each C-rate | | | | |
|---|---|---|---|---|---|---|---|
| Classi- | capacity | ciency | (mAh/g) | | | | |
| fication | (mAh/g) | (%) | 0.2 C | 1 C | 2 C | 3 C | 4 C |
| [symbol] | 353.1 | 92.2 | 353.3 | 327.3 | 169.6 | 84.9 | — |
| [symbol] | 352.0 | 91.3 | 349.2 | 348.1 | 346.3 | 343.3 | 336.4 |

As confirmed in FIG. 1, FIG. 2, and Table 3, when 3 wt % of the carbonaceous material of the present invention is included as an additive ( [symbol] to [symbol] ), high discharge capacity and capacity retention ratio (CRR) were shown even under high-rate discharge conditions.

However, when the carbonaceous material of the present invention is not included as an additive ( [symbol] ) or a carbonaceous material having the physical property values out of those of the present invention is included ( [symbol] ), it was found that charge-discharge was impossible at a high rate, or the capacity was greatly decreased at the high-rate discharge.

### Experimental Example 2

The life characteristics were evaluated for the coin cells manufactured above, according to the evaluation method described above, and the results are shown in FIG. 3.

As seen from FIG. 3, when 3 wt % of the carbonaceous material of the present invention is included as an additive ( [symbol] ), excellent life characteristics were implemented; however, when a carbonaceous material having the physical property values out of those of the present invention ( [symbol] ) was included, the life characteristics were not good.

1. A carbonaceous material for a negative electrode active material additive for a lithium secondary battery having Dᵥ50 of 6 μm or less and Dₙ50 of 1 μm or less,
wherein Dᵥ50 refers to a particle diameter when a cumulative volume is at 50% from a small diameter in a particle size distribution measurement by a laser scattering method, and Dₙ50 refers to a particle diameter when a cumulative number of particles is at 50% from a small particle diameter in a particle size distribution measurement by a laser scattering method.

2. The carbonaceous material of claim 1, wherein the carbonaceous material has Dᵥ10 of 2.2 μm or less and Dₙ10 of 0.6 μm or less,
in which Dᵥ10 refers to a particle diameter when a cumulative volume is at 10% from a small diameter in a particle size distribution measurement by a laser scattering method, and Dₙ10 refers to a particle diameter when a cumulative number of particles is at 10% from a small particle diameter in a particle size distribution measurement by a laser scattering method.

3. The carbonaceous material of claim 1, wherein the carbonaceous material has Dᵥ90 of 11 μm or less and Dₙ90 of 3 μm or less,
in which Dᵥ90 refers to a particle diameter when a cumulative volume is at 90% from a small diameter in a particle size distribution measurement by a laser scattering method, and Dₙ90 refers to a particle diameter when a cumulative number of particles is at 90% from a small particle diameter in a particle size distribution measurement by a laser scattering method.

4. The carbonaceous material of claim 1, wherein the carbonaceous material has a BET specific surface area of 3 m²/g or more and 10 m²/g or less.

5. The carbonaceous material of claim 1, wherein the carbonaceous material has a (002) average layer spacing (d(002)) of 3.4 Å or more and 4.0 Å or less as determined by an X-ray diffraction method.

6. The carbonaceous material of claim 1, wherein the carbonaceous material has a crystallite diameter in a direction of a C-axis, Lc (002) of 0.8 nm or more and 2 nm or less.

7. The carbonaceous material of claim 1, wherein the carbonaceous material is added to a carbon-based negative electrode active material, and an addition amount of the carbonaceous material is 5 wt % or less with respect to 100 wt % of a total amount of the carbon-based negative electrode active material and the carbonaceous material.

8. The carbonaceous material of claim 1, wherein the carbonaceous material includes a carbide obtained by heat-treating a polyurethane resin containing 150 parts by weight or more and 240 parts by weight or less of an isocyanate with respect to 100 parts by weight of a polyol, under an inert gas atmosphere to carbonize the polyurethane resin.

9. The carbonaceous material of claim 8, wherein the polyol is any one or two or more selected from the group consisting of a polyether-based polyol, a polyester-based polyol, a polytetramethylene ether glycol polyol, a poly Harnstoff dispersion (PHD) polyol, an amine-modified polyol, a Mannich polyol, and mixtures thereof.

10. The carbonaceous material of claim 8, wherein the isocyanate is any one or two or more selected from the group consisting of hexamethylene diisocyanate (HDI), isophorone diisocyanate (IPDI), 4,4′-dicyclohexylmethane diisocyanate (H12MDI), polyethylene polyphenyl diisocyanate, toluene diisocyanate (TDI), 2,2′-diphenylmethane diisocyanate (2,2′-MDI), 2,4′-diphenylmethane diisocyanate (2,4′-MDI), 4,4′-diphenylmethane diisocyanate (4,4′-MDI, monomeric MDI), polymeric diphenylmethane diisocyanate (polymeric MDI), orthotoluidine diisocyanate (TODI), naphthalene diisocyanate (NDI), xylene diisocyanate (XDI), lysine diisocyanate (LDI), and triphenylmethane triisocyanate (TPTI).
